(19) United States
(12) Patent Application Publication
(10) Pub. No.: US 2005/0225423 A1
(43) Pub. Date: Oct. 13, 2005

(54) Fast-test printed resistor device with test auxiliary lines

(76) Inventor: Wei Hsu, Taipei Hsien (TW)

Correspondence Address: WEI HSU, 235 CHUNG-HO BOX 8-24, TAIPEI HSIEN, 235, TW

(21) Appl. No.: 10/822,292

(22) Filed: Apr. 12, 2004

(51) Int. Cl. G01L 1/22

(52) U.S. Cl. 338/47; 338/309; 338/2

(57) ABSTRACT

A fast-test printed resistor device with test auxiliary lines on a printed circuit substrate is disclosed. The resistor device comprises at least one first printed circuit foil; at least one second printed circuit foil; a first carbon film resistor sheet connected to the at least one first printed circuit foil; a second carbon film resistor sheet connected to the at least one second printed circuit foil; a first test auxiliary line connected to the first carbon film resistor sheet; and a second test auxiliary line connected to the carbon film resistor sheet; a gap being formed between the first and second test auxiliary lines. One end of each of the two test auxiliary lines is connected to an edge of a respect one of the two carbon film resistor sheets and another end of the test auxiliary line is extended out with a predetermined length for testing.

### FIELD OF THE INVENTION

The present invention relates to printed resistors, and particular to a fast-test printed resistor device with test auxiliary lines.

### BACKGSEMI-ROUND OF THE INVENTION

Resistors are basic elements in circuits. Conventionally, resistors are lump elements, which are made independently and then are assembled to the circuit. However, since recently, most of electronic circuits are made on the printed circuit boards. Thereby, it is necessary that the resistors are necessary to be made directly on the printed circuit board by directly screen-printing technology so as to save the time, labor and cost in manufacturing. This will cause the manufacturing of circuit easy and fast. However, the printed resistors suffer from a disadvantage of larger errors. Thereby, a test process is necessary.

In a printed resistor, resin with carbon is coated on a printed circuit board with bakelite or glass fiber. Thereby, they are confined by the technology so that these kinds of resistors have an error of about 20%. Thereby, the errors of printed resistors are larger than those manufactured by the prior art. In testing the resistance of this printed resistors, the resistors are placed on a pressure controlled sensing circuit of a button type cambered conductive rubber. Variations of the resistors are converted into numerical values to be outputted. If the error of the printed circuit is too larger, the resolution about the variation of the numeric value will become worse so that the quality of the resistor is affected. Since the printed resistors have an error of about 20%, if it is desired to control the errors within a range of 15%, some strict tests to all the resistors are required. However, this will increase the test time and thus the cost is high. Thereby, there is an eager demand for a novel design which can test the printed resistors quickly with a lower cost.

### SUMMARY OF THE INVENTION

Accordingly, the primary object of the present invention is to provide a fast-test printed resistor device with test auxiliary lines on a printed circuit substrate. The resistor device comprises at least one first printed circuit foil; at least one second printed circuit foil; a first carbon film resistor sheet connected to the at least one first printed circuit foil; a second carbon film resistor sheet connected to the at least one second printed circuit foil; a first test auxiliary line connected to the first carbon film resistor sheet; and a second test auxiliary line connected to the carbon film resistor sheet; a gap being formed between the first and second test auxiliary lines. One end of each of the two test auxiliary lines is connected to an edge of a respect one of the two carbon film resistor sheets and another end of the test auxiliary line is extended out with a predetermined length for testing.

The various objects and advantages of the present invention will be more readily understood from the following detailed description when read in conjunction with the appended drawing.

### BRIEF DESCRIPTION OF THE DRAWINGS

FIG. 1 is a whole structural view of the preferred embodiment of the present invention.

FIG. 2 is a partial plane structural schematic view of the preferred embodiment of the present invention.

FIG. 3 shows the circuit arrangement of the present invention.

FIG. 4 is a partial schematic cross view of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

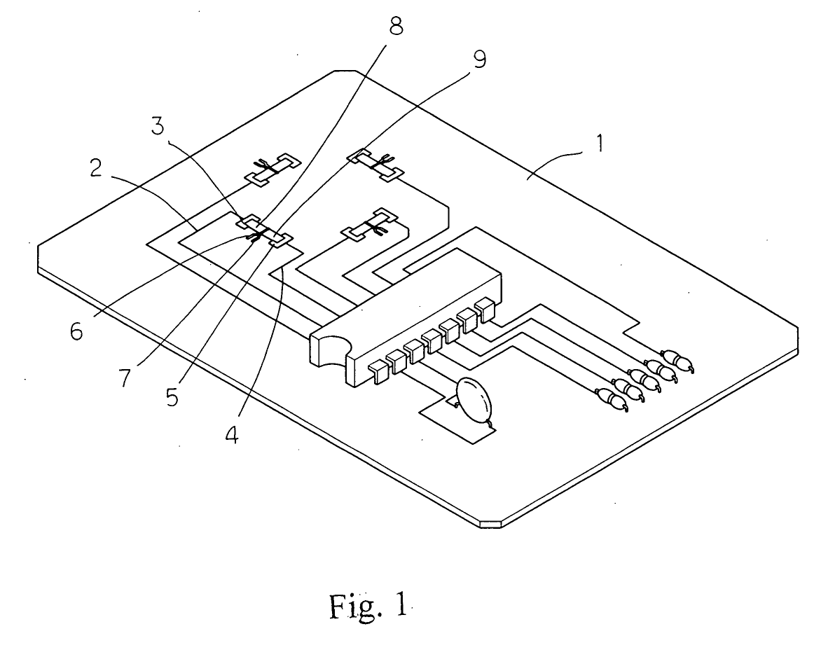

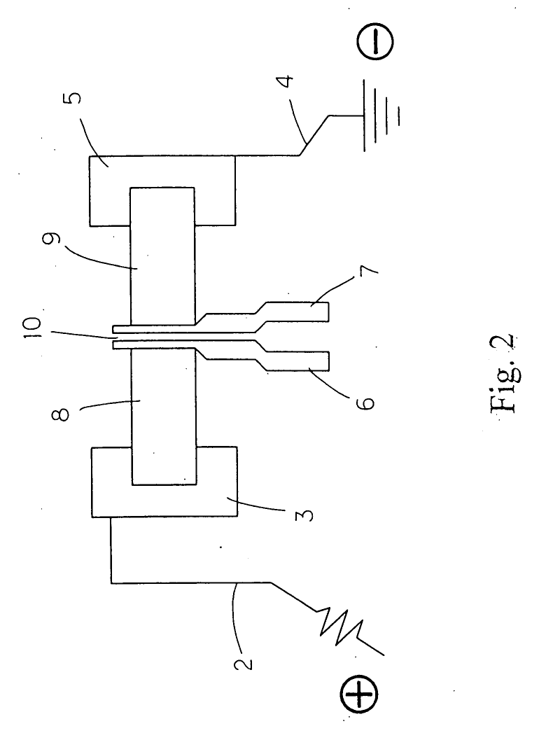

With reference to FIGS. 1 and 2, the fast-test printed resistor according to the present invention is illustrated. In the resistor, resin containing carbon and conductive resin, etc. are coated on a printed circuit substrate 1. The printed circuit substrate 1 has a plurality of printed circuit foils 2,3,4, and 5, test auxiliary lines 6, 7, and carbon film resistor sheets 8, 9. The printed circuit foils 2,4 serve for connecting elements to communicating circuits on the printed circuit substrate 1. The printed circuit foils 3, 5 serve to connect the carbon film resistor sheets 8, 9. A test auxiliary line 6 is connected to the carbon film resistor sheet 8 and another test auxiliary line 7 is connected to the carbon film resistor sheet 9. A gap 10 is formed between the two carbon film resistor sheets 8, 9. Thereby, the two test auxiliary lines 6, 7 do not contact to one another.

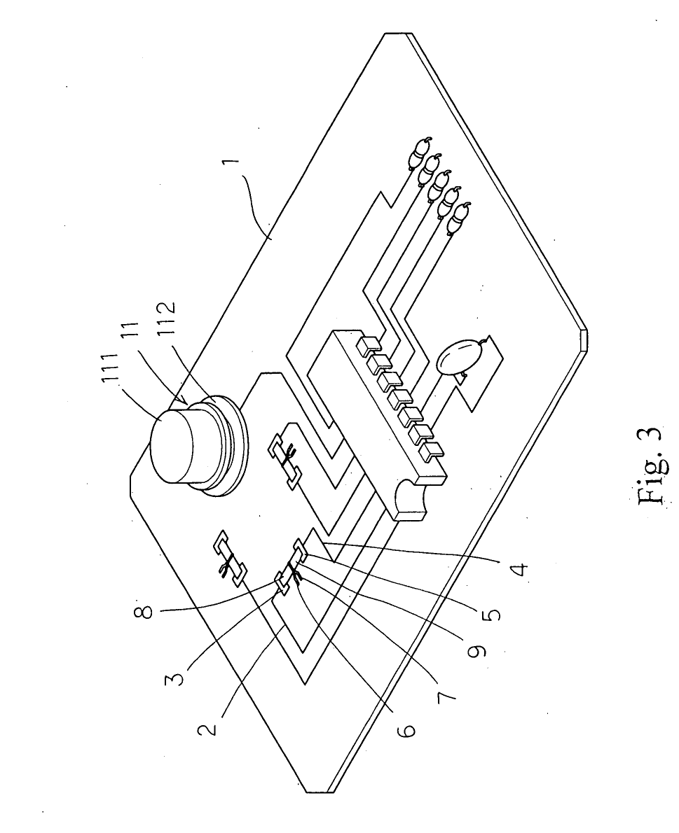

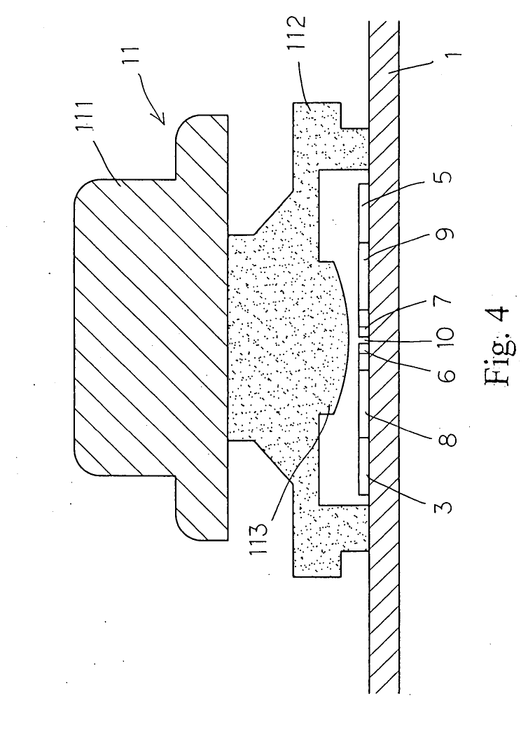

With reference to FIGS. 3 and 4, according to the structure of the fast-test printed resistor of the present invention, in use, a button switch 11 is installed above the printed resistor. The button switch 11 is formed by a button cap 111 and a silicon cover 112. The button cap 111 overlaps upon the silicon cover 112. A conductive rubber 113 with a cambered cross section is installed within the silicon cover 112. By pressing the button cap 111, the two carbon film resistor sheets 8, 9 can be conducted.

In use, when no external force applies to the button cap 111, the conductive rubber 113 is suspended from an inner surface of the silicon cover 112, the silicon cover 112 will cause the conductive rubber 113 to move forwards to contact the two separate carbon film resistor sheets 8, 9 so as to conduct the two carbon film resistor sheets 8, 9. Referring to FIGS. 2 and 3, when the carbon film resistor sheets 8, 9 are conducted, current will flow from the positive electrode, the printed circuit foils 2, 3, the carbon film resistor sheet 8, the conductive rubber 113, the carbon film resistor sheet 9, the printed circuit foils 4, 5 to the negative electrode so as to form an electric loop. In this loop, the resistor is variable, and the variation of current will be measured from the printed circuit foil 2. The test of the resistor can be from two portions. One is the printed circuit foil 3, carbon film resistor sheet 8 and test auxiliary line 6, and the other is the printed circuit foil 5, carbon film resistor sheet 9, and the test auxiliary line 7. By the two test auxiliary lines 6, 7, and the two printed circuit foils 3 and 5, the resistors of the carbon film resistor sheets 8, 9 can be measured.

In the present invention, one end of each of the two test auxiliary lines 6, 7 is connected to an edge of a respect one of the two carbon film resistor sheets 8, 9 and another end of the test auxiliary line is extended out with a predetermined length for testing. Arrangement of this end does not affect other foils on the printed circuit board. Especially, the two carbon film resistor sheets 8, 9 are retained in separation. Thereby, the test of the resistance can be performed mechanically. Thereby, the resistors with larger errors can be taken out so as to have a preferred quality with lower cost and labors.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A fast-test printed resistor device with test auxiliary lines on a printed circuit substrate; the printed circuit substrate having
at least one first printed circuit foil;
at least one second printed circuit foil;
a first carbon film resistor sheet connected to the at least one first printed circuit foil;
a second carbon film resistor sheet connected to the at least one second printed circuit foil;
a first test auxiliary line connected to the first carbon film resistor sheet; and
a second test auxiliary line connected to the second carbon film resistor sheet; a gap being formed between the first and second test auxiliary lines;
wherein the first printed circuit foil, the first carbon film resistor, the first test auxiliary line, the second test auxiliary line, the second carbon film resistor sheet, the second printed circuit foil are sequentially arranged so that the first and second printed circuit foils are at two outer sides of the device, the first and second test auxiliary lines are at inner sides of the device; and the gap is connected the first and second test auxiliary lines, and none of the above elements is located in the gap.

2. The fast-test printed resistor device with test auxiliary lines as claimed in claim 1, wherein one end of each of the two test auxiliary lines is connected to an edge of a respect one of the two carbon film resistor sheets and another end of the test auxiliary line is extended out with a predetermined length for testing; the end of the test auxiliary line does not affect other foil on the printed circuit board.
